(19) United States
(12) Patent Application Publication
(10) Pub. No.: US 2024/0127293 A1
(43) Pub. Date: Apr. 18, 2024

(54) SYSTEM TO ENABLE SPONSORED AD MONETIZATION AND DYNAMIC CONTENT INSERTION AT RUNTIME

(71) Applicant: Catalina Marketing Corporation, St. Petersburg, FL (US)

(72) Inventors: Zubin Singh, San Jose, CA (US); Kirk Dikun, Tampa, FL (US); Ryan Monahan, Orange, CA (US); Hannah Lawrence, St. Petersburg, FL (US); Ronald P. Menich, Marietta, GA (US); Jeremy Dail, St. Petersburg, FL (US); James Zinkovitch, St. Petersburg, FL (US); Angelo Raphael Khoury, Denver, CO (US); Kerul Bharatbhai Suthar, Atlanta, GA (US); Suhas Nadiga, Redmond, WA (US)

(21) Appl. No.: 18/305,567

(22) Filed: Apr. 24, 2023

Related U.S. Application Data
(60) Provisional application No. 63/334,522, filed on Apr. 25, 2022.

(51) Int. Cl. G06Q 30/0272; G06Q 30/0241; G06Q 30/0251

(52) U.S. Cl. CPC G06Q 30/0272; G06Q 30/0249; G06Q 30/0255

(57) ABSTRACT

A method to form an interactive digital payload for consumers is provided. The method includes selecting, based on a prior purchasing behavior for a consumer, a digital payload including a sponsored advertisement and at least one of a targeted advertisement, a coupon or a discount, for a branded product, selecting a slot for the sponsored advertisement within the digital payload, providing the targeted advertisement, the coupon or the discount for the branded product in a second slot within the digital payload, and providing the digital payload to a publishing server for insertion in a media content that is delivered to a client device with the consumer. A system including a memory storing instructions and a processor to execute the instructions and cause the system to perform the above method are also provided.

### CROSS-REFERENCE TO RELATED APPLICATIONS

The present disclosure is related and claims priority under 35 USC § 119(e), to U.S. Prov. Appln. No. 63/334,522, entitled SYSTEM TO ENABLE SPONSORED AD MONETIZATION AND DYNAMIC CONTENT INSERTION AT RUNTIME, to Zubin Singh, et al., filed on Apr. 25, 2022, the contents of which are hereby incorporated by reference in their entirety, for all purposes.

### BACKGROUND

### Field

The present disclosure generally relates to the delivery of sponsored advertisement to consumers through a network via mobile and desktop computer devices running multimedia applications.

### Description of the Related Art

Consumer Packaged Goods (CPG) brands lose about one-third of their consumers every year due mainly to the inefficient advertising techniques typically oriented towards market segmentation through demographics. To improve efficiency, marketing tools available today involve a trade-off between sophistication, selectivity, scalability, and accessibility (e.g., mobile, online, or in-store). However, sophisticated tools are too slow to be useful in the context of consumers of CPGs in a grocery store, and difficult to leverage at the scales desirable for such applications, such as the implementation of geofencing for in-store notifications.

### SUMMARY

In a first embodiment, a computer-implemented method includes selecting a digital payload comprising a sponsored advertisement and at least one of a targeted advertisement, a coupon or a discount, for a branded product, selecting a slot for the sponsored advertisement within the digital payload, providing the targeted advertisement, the coupon or the discount for the branded product in a second slot within the digital payload, and providing the digital payload to a publishing server for insertion in a media content that is delivered to a client device with a consumer.

In a second embodiment, a system includes a memory configured to store multiple instructions, and one or more processors configured to execute the instructions and cause the system to perform operations. The operations include to select a digital payload comprising a sponsored advertisement and at least one of a targeted advertisement, a coupon or a discount, for a branded product, to select a slot for the sponsored advertisement within the digital payload, to provide the targeted advertisement, the coupon or the discount for the branded product in a second slot within the digital payload, and to provide the digital payload to a publishing server for insertion in a media content that is delivered to a client device with a consumer.

In a third embodiment, a computer-implemented method includes receiving, from a publishing server, an identifier for a mobile device of a consumer, wherein the publishing server provides a multimedia content to the mobile device of the consumer, correlating the identifier for the mobile device of the consumer with a purchasing history of the consumer in a retailer network, selecting a sponsored advertisement upon identifying the retailer network, selecting a targeted advertisement based on the purchasing history of the consumer with the retailer network, generating an interactive digital payload with the sponsored advertisement and the targeted advertisement, and providing the interactive digital payload to the publishing server to be inserted in the multimedia content, for the consumer.

In yet another embodiment, a system includes a first means to store instructions and a second means to execute the instructions to cause the system to perform a method. The method includes selecting a digital payload comprising a sponsored advertisement and at least one of a targeted advertisement, a coupon or a discount, for a branded product, selecting a slot for the sponsored advertisement within the digital payload, providing the targeted advertisement, the coupon or the discount for the branded product in a second slot within the digital payload, and providing the digital payload to a publishing server for insertion in a media content that is delivered to a client device with a consumer.

These and other embodiments will become apparent to one of ordinary skill in the art in view of the following.

### BRIEF DESCRIPTION OF THE DRAWINGS

The accompanying drawings, which are included to provide further understanding and are incorporated in and constitute a part of this specification, illustrate disclosed embodiments and together with the description serve to explain the principles of the disclosed embodiments. In the drawings:

FIG. 1 illustrates an example system architecture for a digital promotion engine suitable for practicing some implementations of the disclosure.

FIG. 2 is a block diagram illustrating an example server and client device in the architecture of FIG. 1, according to certain aspects of the disclosure.

FIG. 3 illustrates a system including a mobile device and at least one network server, configured to provide a playlist of personalized MFDs and sponsored advertisements to the user of the mobile device, according to some embodiments.

FIG. 4 illustrates a screenshot of a mobile display provided by a publisher server in a supply side platform, including an advertisement payload provided by a dynamic creative rendering server in a demand side platform, according to some embodiments.

FIG. 5 illustrates screenshots of a display in a consumer mobile device including two modalities of an advertisement carrousel including sponsored slots, according to some embodiments.

FIG. 6 illustrates a screenshot of a digital promotion when a consumer activates the advertisement payload, according to some embodiments.

FIG. 7 illustrates a slot priority selector in an application for a DSP server to prepare an advertisement carrousel including sponsored slots, according to some embodiments.

FIG. 8 illustrates a portal in a DSP server to prepare advertisement carrousels for multiple retailers and products, according to some embodiments.

FIG. 9 illustrates a portal in the DSP server to prepare an advertisement carrousel for a retailer and a product, according to some embodiments.

FIG. 10 is a flow chart illustrating steps in a method for auctioning an advertisement space in a publisher website for an advertisement carrousel from a server, according to some embodiments.

FIG. 11 is a flow chart illustrating steps in a method for preparing an advertisement carrousel to a consumer, according to some embodiments.

FIG. 12 is a block diagram illustrating detailed components in a computer system for use in any of the devices in FIG. 1, according to some embodiments.

In the figures, elements and steps denoted by the same or similar reference numerals are associated with the same or similar elements and steps, unless indicated otherwise.

### DETAILED DESCRIPTION

In the following detailed description, numerous specific details are set forth to provide a full understanding of the present disclosure. It will be apparent, however, to one ordinarily skilled in the art, that the embodiments of the present disclosure may be practiced without some of these specific details. In other instances, well-known structures and techniques have not been shown in detail so as not to obscure the disclosure.

### General Overview

Marketing tools used for advertising universal product codes (UPCs) are largely ineffective, as they are typically based on demographic data for users, rather than their personalized purchasing history and habits. A major drawback for users in the CPG industry is the short time span between receiving an advertisement and executing a purchasing decision, in addition with the high mobility of the users in that same short time span (e.g., while moving through the aisles of a grocery store). This creates a bottleneck for information processing and accessibility in a networked database to provide a desirable advertisement at an appropriate time (e.g., advertising for household maintenance products when the user is in the household items aisle, or in a household item store). In many instances, a brand manufacturer may desire to push a product or a line of products via an advertising campaign, and may desire to sponsor advertisements directly to consumers, via a retail media network.

The disclosed system addresses this problem specifically arising in the realm of computer technology by providing a solution also rooted in computer technology, namely, by a retail media network to sponsor advertisements over a wide range of modalities from mobile, to online, and to the aisle of a grocery store.

The subject system provides several advantages, including providing an engine that enables to push one or more sponsored advertisements from a weekly or other periodical circular or carrousel, among several personalized advertisements and promotions for multiple UPCs. This provides an advantage to the brand manufacturer of the sponsored product, and offers a revenue channel to creative rendering services that support online advertising campaigns. In some embodiments, the carrousel is generated for a retail media network that carries one or more of the multiple UPCs. In some embodiments, the creative rendering services may have multiple retail media networks as clients, and cater to their different advertising desires and configurations. The carrousel may be generated periodically (e.g., once a week) by a retail store in the interest of attracting customers and/or rewarding loyal customers having a frequent consumer identification (FSC ID). The retailer may decide to offer certain slots within the carrousel for promotion under a sponsorship of a given brand manufacturer. The system provides the payload, including the sponsored advertisement, to a user mobile device, based on a digital ID for the consumer, an FSC ID and a purchasing history associated with the FSC ID, a device ID, a cookie ID, an IP address, and the like.

The proposed solution further provides improvements to the functioning of the computer itself because it saves data storage space and reduces network usage (e.g., while transferring a reduced set of advertisements and promotions for display by the mobile device). In addition, some embodiments provide brand manufacturers the ability to remotely sponsor certain advertisements to push products across the board, to all consumers.

Although many examples provided herein describe a user's search inputs or purchasing history being identifiable, or download consumer history, each user may grant explicit permission for such user information to be shared or stored. In some embodiments, a retailer may establish an agreement with consumers registered with a frequent consumer identification to allow a third-party dynamic rendering service in a demand side platform to provide targeted, personalized marketing offers to the consumer. In some embodiments, the consumer may opt out from receiving the marketing offers associated with one or more particular retailers. The explicit permission to participate and allow the targeted, personalized marketing offers may be granted using privacy controls integrated into the disclosed system. Each user may be provided notice that such user information will be shared with explicit consent, and each user may at any time terminate the information sharing, and may delete any stored user information. The stored user information may be encrypted to protect user security.

In some embodiments, methods as disclosed herein combine a predictive model to score a periodic deal offer content to a user (e.g., daily or weekly retailer circular) with basic category interest data for online offers. Some of the category interest data may include CPG categories such as “baby,” “beverage,” “food,” “general merchandise,” “health & beauty,” “over-the-counter,” “pet,” and the like. Some embodiments may include in-store shopping data for multiple users, available in a database through a network. In some embodiments, methods as disclosed herein include scoring circular advertisement item content (e.g., temporary price reductions), sourced by grocery retailers subscribed to a network service. Some embodiments include predicting circular advertisement item performance and modeling consumer behavior to predict likelihood of purchasing items in the retailer circular, for example by using machine learning algorithms, or appropriately trained neural networks.

In some embodiments, methods as disclosed herein may offer CPG brands the opportunity to sponsor advertisements for selected products and bundle those sponsored advertisements within personalized advertisement payloads.

In some embodiments, for every retailer, they are allowed two sponsorship slots within a given carrousel.

### Example System Architecture

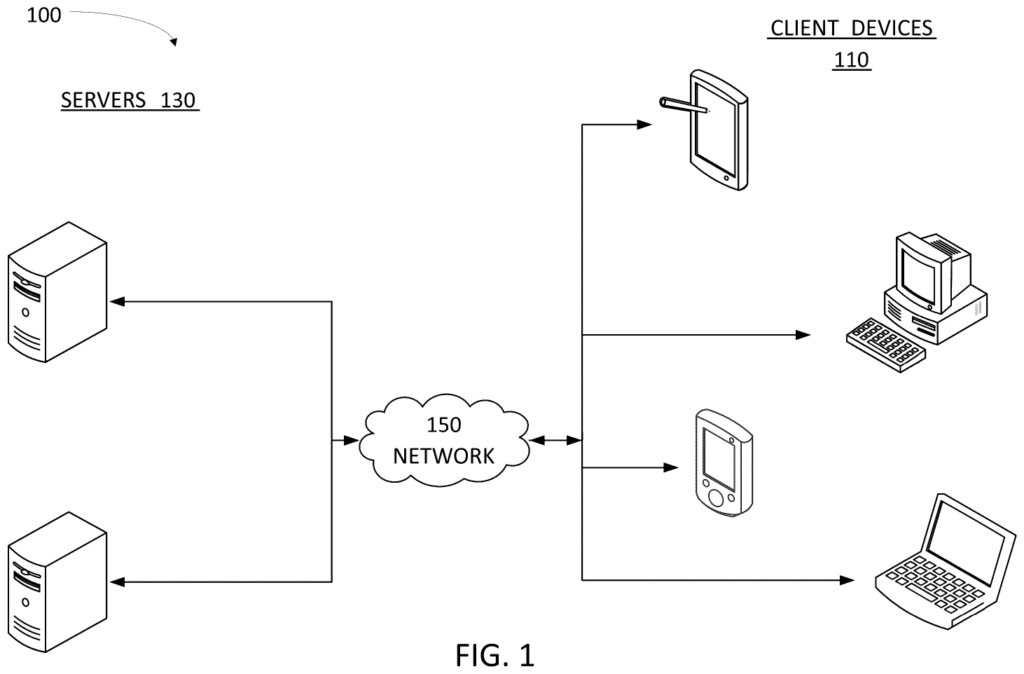

FIG. 1 illustrates an example system architecture 100 for a digital promotion engine suitable for practicing some implementations of the disclosure. Architecture 100 includes servers 130 and client devices 110 coupled over a network 150. One or more of the many servers 130, and the client devices 110 are configured to host a memory, including instructions which, when executed by a processor, cause the server 130 or device 110 to perform at least some of the steps in methods as disclosed herein. In some embodiments, architecture 100 is configured to present personalized digital promotions to a consumer, who may be the consumer of client device 110. The targeted digital promotion payload may be retrieved from a purchase history of the consumer, which may be stored in a history log in a memory of the server. In addition, the digital promotion may include sponsored advertisements promoted by a brand manufacturer or a retailer, appearing in a prominent position of the advertisement payload.

Servers 130 may include any device having an appropriate processor, memory, and communications capability for hosting the history log, the digital promotion database, and a digital promotion engine. The digital promotion engine may be accessible by various clients 110 over the network 150. In some embodiments, servers 130 may include a dynamic creative rendering server, a publisher, or supply side platform (SSP) server, and a demand side platform (DSP) server. Client devices 110 may include, for example, desktop computers, mobile computers, tablet computers (e.g., including e-book readers), mobile devices (e.g., a smartphone or PDA), or any other devices having appropriate processor, memory, and communications capabilities for accessing the image search engine and the history log on one or more of servers 130. Network 150 can include, for example, any one or more of a local area network (LAN), a wide area network (WAN), the Internet, and the like. Further, network 150 can include, but is not limited to, any one or more of the following network topologies, including a bus network, a star network, a ring network, a mesh network, a star-bus network, tree or hierarchical network, and the like.

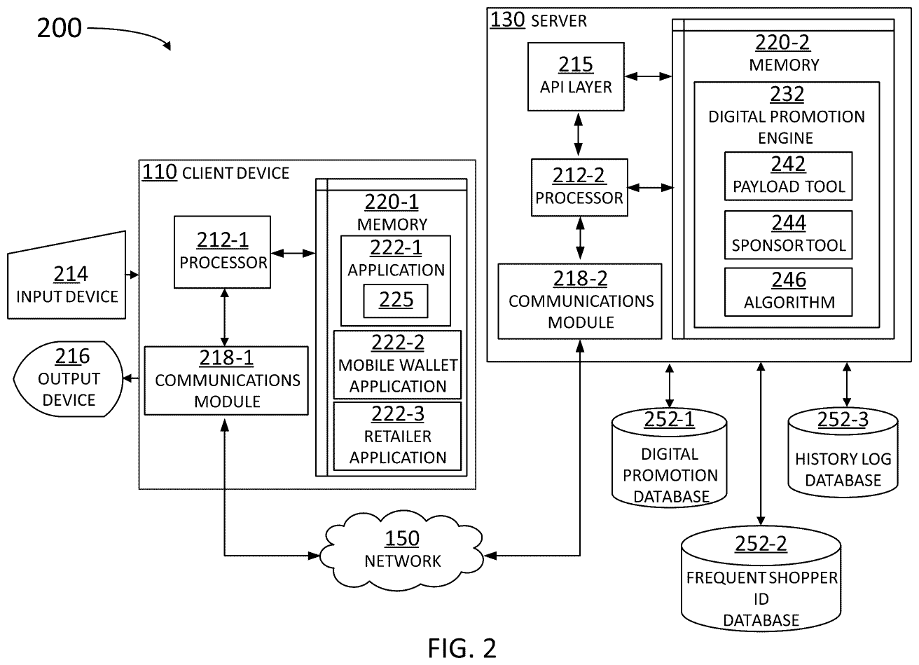

FIG. 2 is a block diagram 200 illustrating an example server 130 and client device 110 in the architecture 100 of FIG. 1, according to certain aspects of the disclosure. Client device 110 and server 130 are communicatively coupled over network 150 via respective communications modules 218-1 and 218-2 (hereinafter, collectively referred to as “communications modules 218”). Communications modules 218 are configured to interface with network 150 to send and receive information, such as data, requests, responses, and commands to other devices on the network. Communications modules 218 can include, for example, modems or Ethernet cards. Client device 110 may be coupled with an input device 214 and with an output device 216. Input device 214 may include a keyboard, a mouse, a pointer, or even a touch-screen display that a consumer may use to interact with client device 110. Likewise, output device 216 may include a display and a speaker with which the consumer may retrieve results from client device 110. Client device 110 may also include a processor 212-1, configured to execute instructions stored in a memory 220-1, and to cause client device 110 to perform at least some of the steps in methods consistent with the present disclosure. Memory 220-1 may further include an application 222-1, including specific instructions which, when executed by processor 212-1, cause a digital promotion payload 225 from server 130 to be displayed for the consumer. Digital promotion payload 225 may include multiple digital promotions or coupons presented to the consumer by server 130, and the consumer may store at least some of the digital promotions or coupons from digital promotion payload 225 in memory 220-1.

In some embodiments, memory 220-1 may include a mobile wallet application 222-2, configured to store a value offer (e.g., a coupon, a discount, and the like), which has been selected (e.g., “clipped”) by the consumer from any one of the multiple digital promotions or coupons in digital promotion payload 225. Further, in some embodiments, mobile wallet application 222-2 may associate the value offer selected by the consumer to an FSC-ID for the retailer stored in memory 220-1. Mobile wallet application 222-2 may be installed in memory 220-1 by the manufacturer, together with the installation of an operating system that controls all hardware operations of client device 110. Moreover, in some embodiments, a consumer may download a retailer application 222-3 in client device 110 for the retailer. The consumer may have an FSC ID associated with retailer application 222-3. In some embodiments, in addition to one or more “brick and mortar” physical locations of stores for the retailer, the retailer may host an online shopping outlet hosted by a network server (e.g., server 130). Application 222-1, mobile wallet application 222-2, and retailer application 222-3 will be collectively referred to, hereinafter, as “applications 222.”

Server 130 includes a memory 220-2, a processor 212-2, and a communications module 218-2. Processor 212-2 is configured to execute instructions, such as instructions physically coded into processor 212-2, instructions received from software in memory 220-2, or a combination of both. Memory 220-2 includes a digital promotion engine 232 for integrating images, videos, and other multimedia files stored in a digital promotion database 252-1 into digital promotion payload 225. Digital promotion engine 232 includes a payload tool 242 and a sponsor tool 244. Payload tool 242 puts together the digital content (images, videos, and other widgets) in digital promotion payload 225. Sponsor tool 244 verifies the settings for a sponsored advertisement and ensures that payload tool 242 includes the sponsored advertisement in the proper place within digital promotion payload 225. Digital promotion engine 232 may push digital promotions from digital promotion database 252-1 to a consumer of client device 110 that is a consumer of a retailer store or chain of stores through an application 222-1 or a web browser installed in client device 110. Accordingly, applications 222 may be installed by server 130 and perform scripts and other routines provided by server 130. In some embodiments, application 222-1 may be configured to display digital promotion payload 225 provided by digital promotion engine 232. Processors 212-1 and 212-2, and memories 220-1 and 220-2, will be collectively referred to as “memories 220” and “processors 212.” An application programming interface (API) layer 215 interfaces between digital promotion engine 232 and applications 222, makes calls to server 130 requesting data, and pushes data into applications 222, accordingly.

Digital promotion engine 232 integrates digital promotion payload 225 based on information retrieved from a frequent shopper identification database 252-2 and a digital promotion database 252-1. Digital promotion database 252-1 includes the purchase history of multiple consumers listed in frequent shopper identification database 252-2. To achieve this, in some embodiments, an algorithm 246 stores commands which, when executed by processor 212-2, causes server 130 to integrate digital promotion payload 225. Algorithm 246 may include a neural network (NN) trained over frequent shopper identification database 252-2 and digital promotion database 252-1, to select digital promotion payload 225 targeted to the specific preferences of a consumer when the consumer uses any one of applications 222 to access a network site hosted by server 130 (e.g., an SSP server). Accordingly, the SSP server hosting the network site accessed through application 222 may be different from a DSP server hosting digital promotion engine 232.

In one or more implementations, digital promotion database 252-1 integrates digital promotion payloads including coupons and digital promotions for multiple products on sale by a retailer having one or more stores. A frequent shopper identification database 252-2 may include a list of frequent consumers of the retailer. The retailer may create, update, and maintain digital promotion database 252-1, frequent shopper identification database 252-2, and history log database 252-3. In that regard, digital promotion database 252-1, frequent shopper identification database 252-2, and history log database 252-3 may be hosted by the retailer, while the digital promotion engine 232 may be hosted by a DSP server or a dynamic creative rendering server. Accordingly, the DSP server may have access to one or more digital promotion databases 252-1, to one or more frequent shopper identification databases 252-2, and to one or more history log databases 252-3 through business agreements with one or more retailers.

In certain aspects, processor 212-2 in a server 130 hosted by a retailer is configured to determine data for digital promotion database 252-1 by obtaining consumer purchasing data identifying the consumer via the frequent shopper identification used at multiple purchasing events in multiple locations, over a pre-selected span of time. In some embodiments, digital promotion database 252-1 includes online purchasing history for the consumer through applications 222 or a network browser. Hereinafter, digital promotion database 252-1, frequent shopper ID database 252-2, and history log database 252-3 will be collectively referred to as “databases 252.”

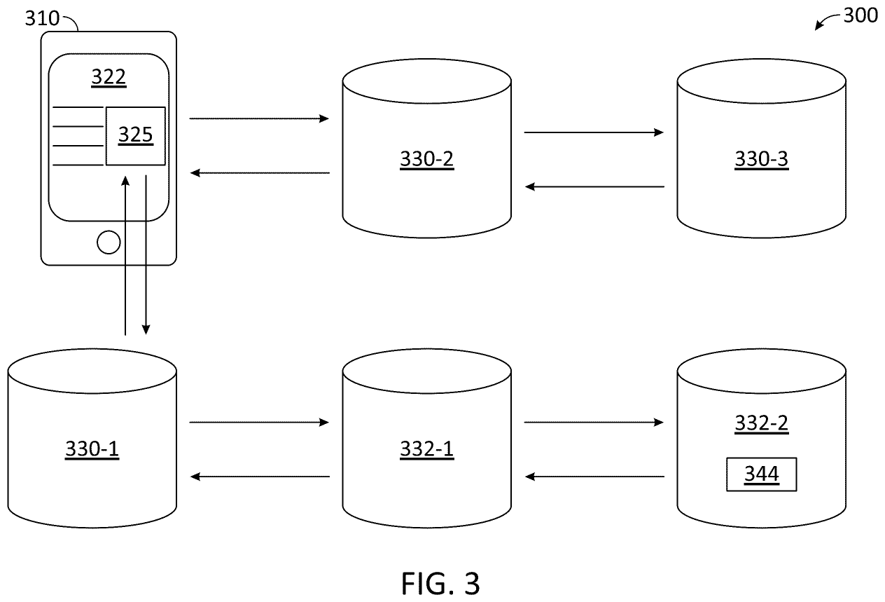

FIG. 3 illustrates a system 300, including a mobile device 310 and at least one publisher server 330-2 (e.g., a supply side platform—SSP—server), hosting a website 322 that is accessible via mobile device 310, according to some embodiments. Website 322 may include, in addition to the SSP-related information, a playlist 325 of personalized “My Favorite Deals” (e.g., provided by an MFD engine 332-1) to the user of mobile device 310 (e.g., a consumer), according to some embodiments. A sponsored advertisement engine 332-2 provides sponsored advertisements to MFD engine 332-1. Sponsored advertisement engine 332-2 may include a sponsor tool 344 (cf. sponsor tool 244) to handle requests from retailers and brand manufacturers to include sponsored advertisements, promotions, and coupons in an MFD playlist 325. In some embodiments, a server 330-3 in a retailer network may sponsor one or more advertisements provided to sponsored advertisement engine 332-2 and ultimately to the consumer (e.g., mobile device 310). SSP server 330-2 may be associated with a retailer media network, or may be a news outlet, or a media content provider (e.g., movies, TV series, games, and other entertainment). Accordingly, MFD playlist 325 may be a dynamic, interactive payload including a carrousel with multiple advertisements and offers selected for the consumer including sponsored advertisements arranged in sequence as numbered slots. The consumer may scroll through the MFD playlist 325 or carrousel by clicking on a sequence arrow, and watch/select one or more of the advertised products as desired. Publisher server 330-2 may include a memory and a processor (cf. memories 220, processors 212), wherein the memory may include, or may have access to, a database including a lookup table pairing a mobile device identifier (e.g., a mobile cookie ID or mobile advertising device identifier) with a retail-specific FSC ID, such as illustrated in Table I, below (cf. databases 252). In embodiments consistent with the present disclosure, the mobile cookie ID may be a mobile advertising device identifier, which in some embodiments may be different from a mobile device identifier used by a network service provider that services the operating system of the mobile device itself.

TABLE I

| Mobile Cookie ID | Database Retailer's FSC ID |
|---|---|
| hsh192zur94 | 384759 |
| Su928470184 | 495038 |

*Table I values are illustrative for example purposes

MFD engine 332-1 may include a platform designed to score and rank the most relevant offers for a specific consumer from a pool of available retailer CPG content. For this, MFD engine 332-1 may access a historical consumer item level (cf. history log database 252-3), in-store purchase data from grocery retailers and online activity based on a predictive, computer-based method. In some embodiments, the method combines three components: an overall prediction of the offer performance (base rate), individual in-store shopping behavior and online interactions to predict a given consumer's likelihood to respond to each offer, and client specific business rules to adjust offer ranking based on secondary objectives. MFD engine 332-1 scores most or all of the offers for a consumer in near real time. In some embodiments, MFD engine 332-1 is able to score the offers in under 500 milliseconds (ms), at the time of transaction, using up-to-date consumer data available, to place in MFD playlist 325. In addition to consumer-personalized advertisements, MFD engine 332-1 may be configured to include sponsored advertisements in MFD playlist 325. In some embodiments, MFD engine 332-1 is extensible to accommodate a variety of offers including digital “load-to-card” offers, print at home coupons, and circular advertisements for omni-channel delivery (e.g., in-store, online, email, and mobile).

In some embodiments, MFD engine 332-1 is configured to select a few (e.g., ten, five, or maybe fewer, or more) of the most relevant weekly promotional deals for the consumer based on past in-store shopping behavior for the user, on a unique product code (UPC) data, and on promotion details. The MFD engine may have access to several data sources, including the retailer's UPC Product Dictionary, Weekly Circular Ads, In-Store Point of Sale data, and Loyalty Card IDs.

A demand-side platform (DSP) server 330-3 may include attributes from a display of mobile device 310 and a publisher website 322. DSP server 330-3 is configured to receive a request for an advertisement from SSP server 330-2 to which mobile device 310 has access. In some embodiments, SSP server 330-2 sends a bid request to DSP server 330-3 for advertising space in website 322 provided to mobile device 310. Accordingly, DSP server 330-3 may reply with a bid response including MFD playlist 325. In some embodiments, the SSP server 330-2 may conduct an auction for bids received from one or more vendors, retailers, and/or brand manufacturers, and select the bid response from DSP server 330-3. Further, SSP server 330-2 may deliver MFD playlist 325 (e.g., an advertisement carrousel) to website 322 in consumer mobile device 310. In some embodiments, MFD playlist 325 may include a script (e.g., a javascript, “.js” code) to render the dynamic creative ad unit.

Browser (or mobile application) 322 may call a dynamic creative rendering server 330-1 to fetch the MFD playlist 325 including one or more digital promotions and/or coupons. Dynamic creative rendering server 330-1 may be configured to identify the incoming HTTP application programming interface (API) calling from a browser or an application 322, containing an identifier for mobile device 310. Dynamic creative rendering server 330-1 may then execute commands in an API to provide the identifier of the consumer mobile device to MFD engine 332-1.

MFD engine 332-1 may be configured to execute logic commands that use the identifier of mobile device 310 and crosswalk an ID mapping table (e.g., Table I, above) to look up the corresponding retailer's FSC ID (frequent consumer identification ID, cf. database 252-2). MFD engine 332-1 may also be configured to execute internal logic to query the retailer's FSC ID. MFD engine 332-1 may then return a “j son” or an “.xml” playlist of structured MFD content to dynamic creative rendering server 330-1.

In some embodiments, the logic commands used in MFD engine 332-1 include a combination of a content-based filtering recommendator system (e.g., that may be used to recommend music choices for a user), a Recency-Frequency-Monentary (RFM) Model, which may also be used for direct marketing campaigns, and predictive statistical modeling. In embodiments consistent with the present disclosure, MFD engine 332-1 solves at least two problems encountered in the realm of computer techniques for personalized and mobile marketing strategies. First, a scalable way to personalization CPG and grocery offers when the pool of content is relatively large (more than 300 offers in a retailer circular, for example) for each individual consumer. Traditionally, segmentation (e.g., user demographics, and the like) and look-a-like models have been used to group consumers and then select the most appropriate offers. A personalization algorithm as used in the logic commands executed by MFD engine 332-1 is an effective way to determine the most relevant offers based on the unique behavior of the user. Second, the logic commands executed by MFD engine 332-1 execute rapidly, calculating the score and delivering the recommendations in under 500 ms, according to some embodiments.

Dynamic creative rendering server 330-1 pushes the dynamic “j son” or “.xml” playlist content provided by MFD engine 332-1 onto mobile device 310. Accordingly, the “.json” or “.xml” playlist may include a list of limited advertisement items (e.g., ads, coupons, and the like) that may be rendered within a Dynamic Creative ad unit invoked and displayed on mobile device 310 by SSP server 330-2. Thus, advertisement items will be rendered and displayed in mobile device 310 for the user quickly and efficiently (e.g., as the user walks through the aisles in a grocery store, or at the cashier, to apply coupons at the time of payment). In some embodiments, including geofencing for in-store notifications, dynamic creative rendering server 330-1 pushes the dynamic “.json” or “.xml” playlist content when it is determined that mobile device 310 is within the confines of a retail store subscribed to a system as disclosed herein, wherein CPGs identified with UPCs handled by MFD engine 332-1 are sold.

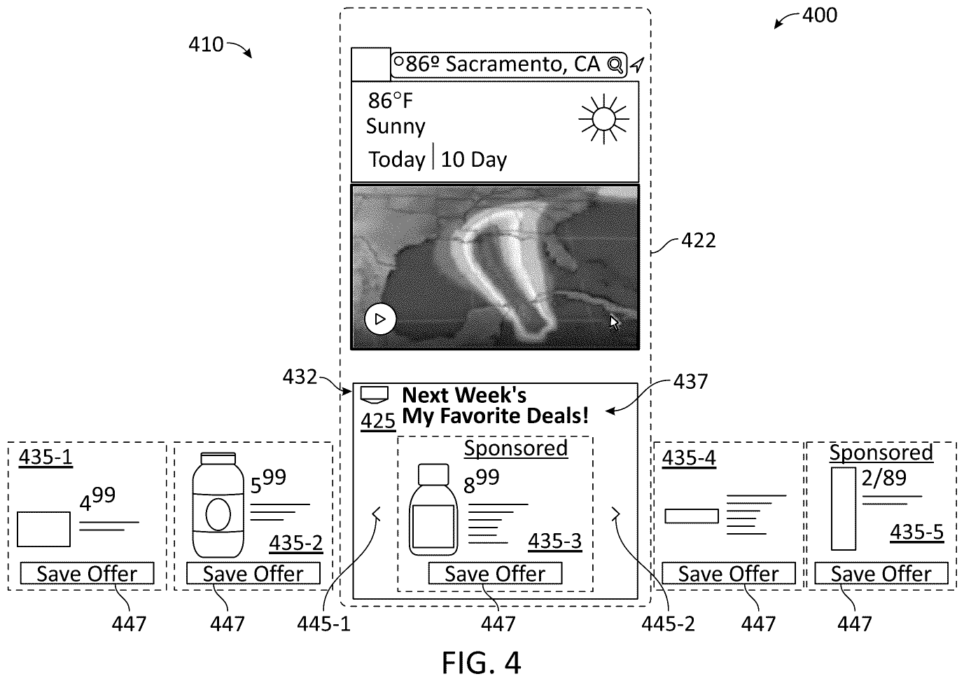

FIG. 4 illustrates a screenshot of a mobile display 400 provided by a publisher server in a supply side platform (e.g., publisher server 330-2), including an advertisement carrousel 425 provided by a dynamic creative rendering server 330-1 in a demand side platform, according to some embodiments. Mobile display 400 may include a webpage 422 accessed by a browser or a mobile application installed in a consumer client device 410.

Accordingly, the publisher server may auction a portion of mobile display 400 for advertisement space to a DSP server that includes an advertisement engine (cf. DSP server 330-3 and MFD engine 332-1). After presenting a winning bid for the advertising space with the publisher server, the DSP server may then provide advertisement carrousel 425 including advertisements for products and items for sale at the retailer 432 that has won the bid. Advertisement carrousel 425 may include an ordered sequence of multiple slots 435-1, 435-2, 435-3, 435-4, and 435-5 (hereinafter, collectively referred to as “slots 435”) with digital promotions in each. Some promotions may be sponsored advertisements (cf. slot 435-3 and 435-5), provided by a sponsored advertisement engine including a sponsor tool, as disclosed herein (cf. sponsored advertisement engine 332-2 and sponsor tool 244). Other promotions may include personalized advertisements (cf. slots 435-1, 435-2, and 435-4). In some embodiments, advertisement carrousel 425 may include scrolling features 445-1 and 445-2 (hereinafter, collectively referred to as “scrolling features 445”) so that the consumer may browse through the different advertisement slots 435.

In some embodiments, advertisement carrousel 425 includes a plugin 437 from the retailer server to access, from consumer mobile device 410, an application or a website hosted by the retailer. By clicking on a retailer icon 432, the consumer may be directed to a retailer website or application, wherein the consumer may in fact browse for, and select, more digital promotions from the retailer. In some embodiments, upon clicking a “save offer” button 447 in one of advertisement slots 435, the consumer may be prompted to install a retailer application (when the retailer application is not already installed in client device), or to launch the retailer application (when the retailer application is already installed in consumer mobile device 410). Moreover, upon activating save offer button 447, the DSP server may prompt the consumer to save one or more of loaded digital promotions in slots 435 in a memory of consumer mobile device 410, or in a personalized wallet or shopping cart for the consumer, in the retailer website. For example, the DSP server may prompt the consumer to save advertisement carrousel 425 in a memory of mobile device 410, in a memory of the DSP server, or in a memory of a retailer server.

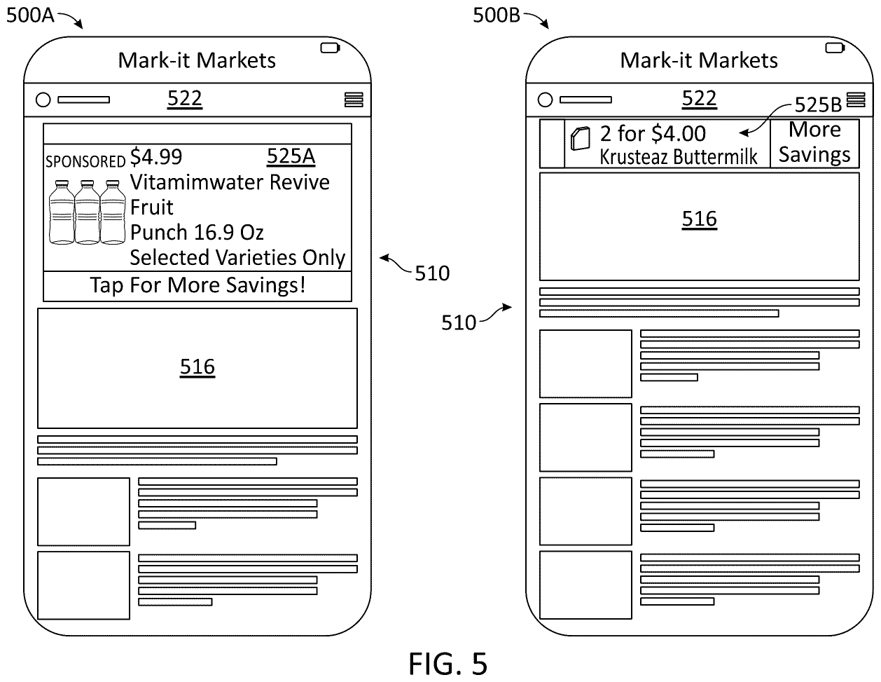

FIG. 5 illustrates screenshots 500A and 500B (hereinafter, collectively referred to as “screenshots 500”) of a display in a consumer mobile device 510. A webpage 522 includes two modalities of an advertisement carrousel, 525A and 525B (hereinafter, collectively referred to as “carrousels 525”), including sponsored slots, according to some embodiments. In carrousel 525A, a bigger icon takes a larger portion of mobile screen 516, thereby having a greater chance to attract the consumer's eyeballs. In carrousel 525B, a banner-like strip occupies a smaller portion of mobile screen 516, providing a less invasive experience for the consumer.

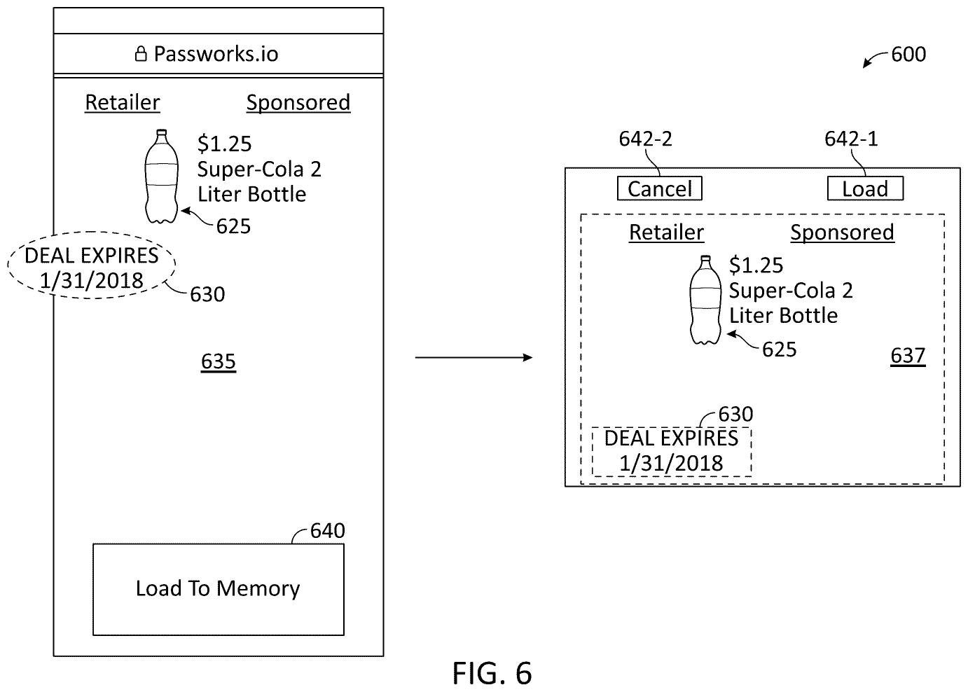

FIG. 6 illustrates a screenshot 600 of a sponsored digital promotion 625 when the consumer activates a “load to memory” button 640 in one of the advertisement slots (e.g., for the sponsored advertisement) in the advertisement carrousel (cf. slots 435-3 or 435-5 in carrousel 425), according to some embodiments. Sponsored promotion 625 may be generated and promoted by a sponsored advertisement engine. In some embodiments, load to memory button 640 in an advertisement slot enables the consumer to load the digital promotion into a memory of the mobile device (e.g., a digital wallet). When load to memory button 640 is activated, some embodiments display a digital promotion preview 637, including an expiration date 630. Digital promotion preview 637 may include “Load” and “Cancel” buttons (642-1 and 642-2, respectively, and collectively referred to, hereinafter, as “buttons 642”), to load advertisement slot 635 to the memory, or cancel the operation. The consumer may bring all the promotions uploaded to memory (sponsored or otherwise) using the FSC ID at the retailer store (“brick and mortar,” or online), or at any other point in time or place.

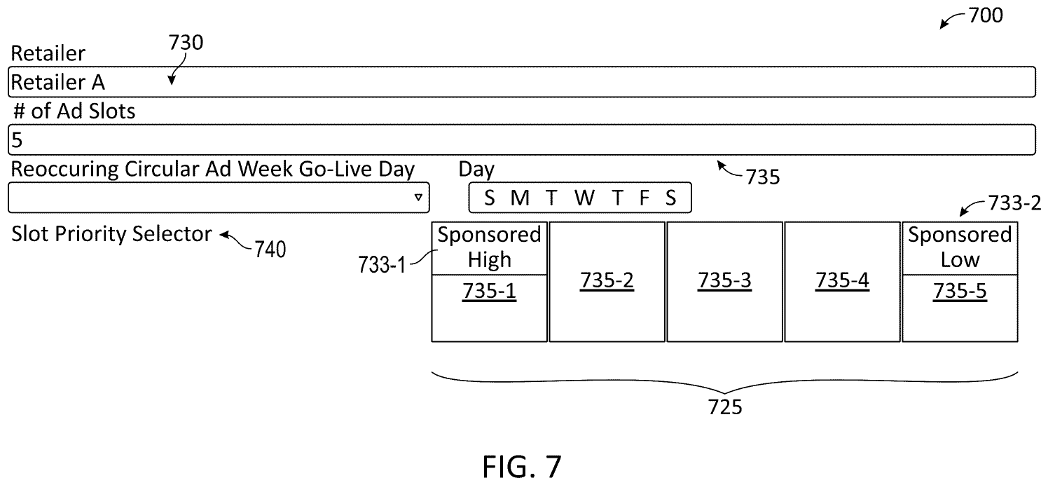

FIG. 7 illustrates a slot priority selector 700 in an application for a DSP server to prepare an advertisement carrousel 725 including sponsored slots 735-1 and 735-5, according to some embodiments. Sponsored slots 735-1 and 735-2 may be generated by a sponsored advertisement engine including a sponsored tool, as disclosed herein (cf. sponsored advertisement engine 332-2 and sponsor tools 244 and 344). Accordingly, retailer 730 (“Retailer A”) has requested two slots out of a total of five slots 735-1, 735-2, 735-3, 735-4, and 735-5 (hereinafter, collectively referred to as “slots 735”) in carrousel 725 to be assigned for sponsored advertisements. In some embodiments, retailer 730 may choose which of the five slots (shown in the sequence they are scrolled by the consumer in the mobile application or website) are assigned as sponsored slots. In general, the sequence of scrolling of slots 735 is from left to right, and at least one slot will be a sponsored advertisement. Slot 735-1 is the one that appears first as the consumer scrolls over carrousel 725, and thus has a “high” priority 733-1 for the retailer. When there are two sponsored advertisements, the slot to the right may have a “low” priority 733-2 for the retailer (hereinafter, collectively referred to as “priority ranks 733”). The priority of the sponsored slots is set by a slot priority selector 740.

Accordingly, a retailer may charge a higher value to a brand manufacturer for sponsoring an advertisement in a higher priority rank 733 in carrousel 725.

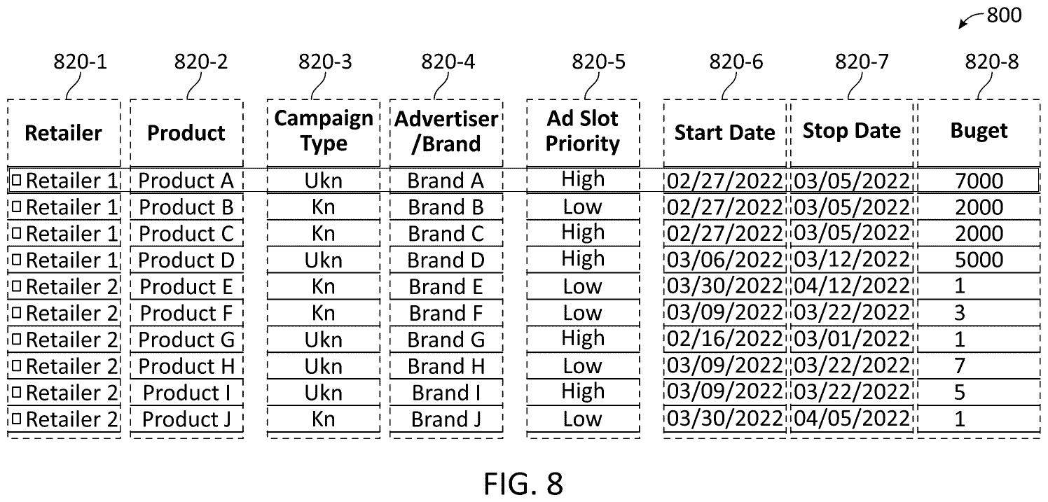

FIG. 8 illustrates a portal 800 in a DSP server (cf. DSP server 330-3) to prepare sponsored advertisements for multiple retailers 820-1 and products 820-2, according to some embodiments. Accordingly, a DSP server manager may store multiple sponsored advertisements for retailer 1 and retailer 2. Each sponsored advertisement includes a product 820-2, a campaign type 820-3, an advertiser or brand manufacturer 820-4, and an ad slot priority 820-5 for that specific advertisement. In addition, the DSP server offers the opportunity to the clients (e.g., each of the retailers 820-1 or brand manufacturers or advertisers 820-4) a start/stop date 820-6/820-7 for the advertisement to show in the advertisement carrousels. A budget 820-8 for each advertisement slot is also listed (higher for a high priority slot, lower for a low priority slot, cf. priority ranks 733).

With a list as shown in portal 800, the DSP server generates advertisement carrousels having advertisement slots for the selected products according to the selected priority rank (cf. carrousels 425, 525, and 725, and priority ranks 733). The DSP server then bids for advertisement space in a publishing server to direct the carrousel to the consumer mobile devices (cf. publishing server 330-2 and mobile devices 410 and 510). The DSP server may request the publishing server to place the advertisement carrousel for consumers that may be identified to be preferred customers for a given retailer.

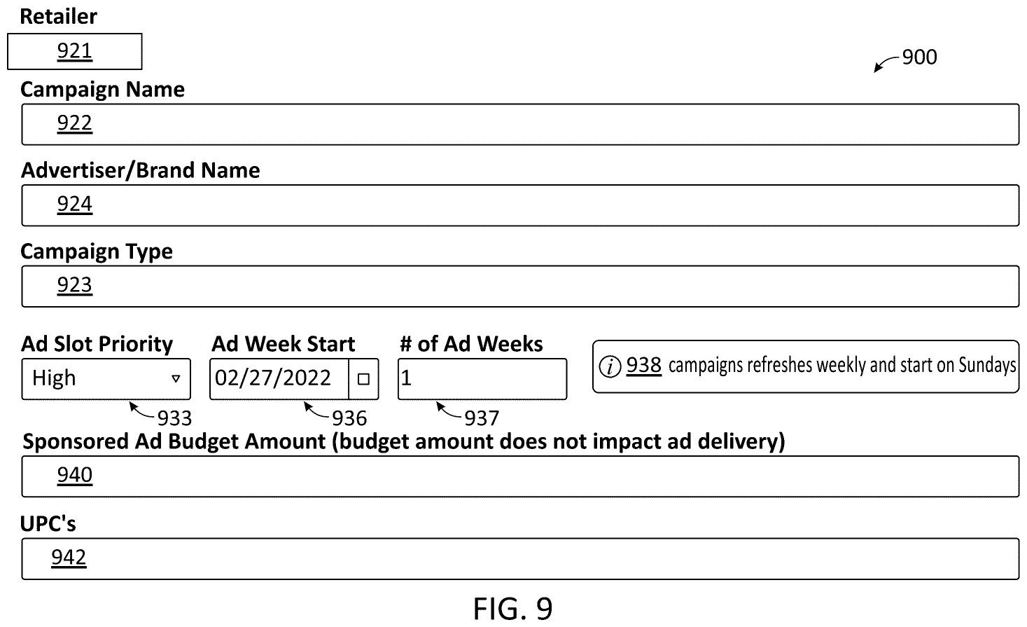

FIG. 9 illustrates a portal 900 in a DSP server to prepare an advertisement carrousel for a retailer 921 and a product 942 (cf. DSP server 330-3 and carrousels 425, 525, and 725), according to some embodiments. A brand name 924 indicates the product to be advertised. A campaign name 922, a campaign type 923, and a sponsored ad budget 940 may also be selected. The user may also indicate a slot priority 933, a start date 936, and a period 937 for which the campaign should be running. An informational note 938 in the display may indicate desired features of the campaign such as that the carrousel be refreshed weekly for that specific retailer. Accordingly, each week of the campaign, the DSP server prepares a new carrousel for the retailer based on the products that are listed for the DSP server (cf. FIG. 8).

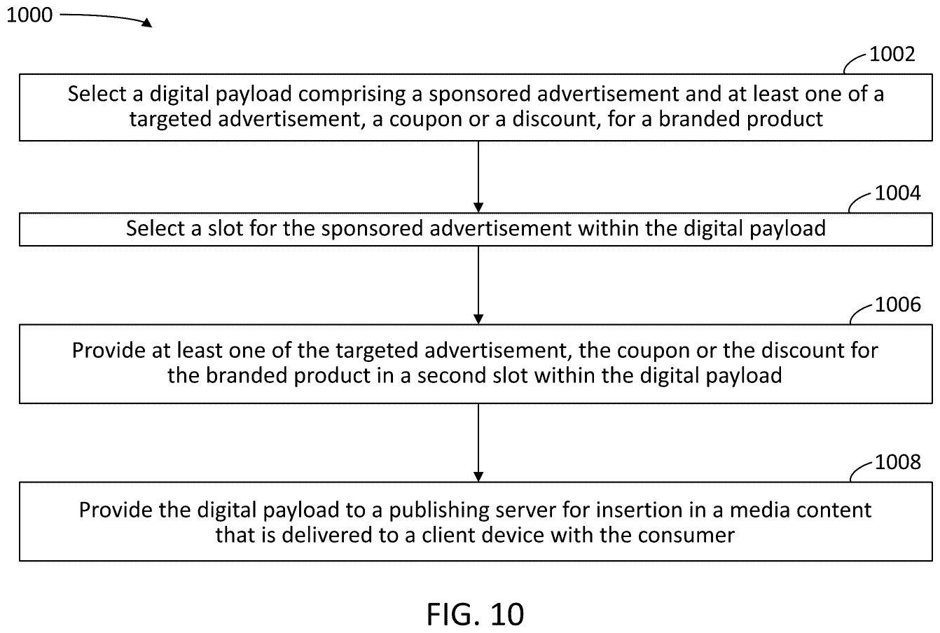

FIG. 10 illustrates steps in a method 1000 for auctioning an advertisement space in a publisher website for an advertisement carrousel from a DSP server (cf. publisher server 330-2, DSP server 330-3, and website 322), according to some embodiments. Method 1000 may be performed at least partially by any one of a plurality of servers in a network architecture as disclosed herein (cf. servers 130, network architecture 100). For example, at least some of the steps in method 1000 may be performed by one component in a system, including a mobile device running code for a browser and an application to access the publisher website, a digital promotion engine, an MFD engine, and a sponsored advertisement engine (client devices 110, 410, 510, website 322, publisher server 330-2, digital promotion engine 232, MFD engine 332-1, and sponsored advertisement server 332-2). The engines include tools such as a payload tool, a sponsor tool, and an algorithm (cf. payload tool 242, sponsor tools 244 and 344, and algorithm 246). The tools process logic to select an advertisement payload for a dynamic creative rendering server to push the advertisement payload to the mobile device (cf. advertisement payloads, carrousels or ad units 225, 325, 425, 525, 625, and 725). The publisher SSP server may request advertisement bids from, and is registered with, the DSP server. Accordingly, at least some of the steps in method 1000 may be performed by a processor executing commands stored in a memory of the server, or accessible by the server, and executed by one or more processors (cf. memories 220, processors 212). The servers and the mobile device may be communicatively coupled via a network, with one or more databases (cf. network 150 and databases 252). Further, in some embodiments, at least some of the steps in method 1000 may be performed overlapping in time, almost simultaneously, or in a different order from the order illustrated in method 1000. Moreover, a method consistent with some embodiments disclosed herein may include at least one, but not all, of the steps in method 1000.

Step 1002 includes selecting a digital payload including a sponsored advertisement and at least one of a targeted advertisement, a coupon or a discount, for a branded product. In some embodiments, step 1002 includes selecting the sponsored advertisement from a list provided to a server by a retailer pushing multiple products in advertising campaigns. In some embodiments, step 1002 includes identifying, from a list of multiple advertisement items provided by multiple retailers, one or more advertisement items from one of the retailers, based on a selected time window of a campaign associated with the advertisement items. In some embodiments, step 1002 includes selecting the sponsored advertisement and the at least one of the targeted advertisement, the coupon, or the discount associated with a product for sale at a retailer, based on a request from the retailer received in a network server.

Step 1004 includes selecting a slot for the sponsored advertisement within the digital payload. In some embodiments, step 1004 includes selecting one of a high priority slot or a low priority slot based on a budget provided by a retailer for a product associated with the sponsored advertisement.

Step 1006 includes providing the targeted advertisement, the coupon, or the discount for the branded product in a second slot within the digital payload. In some embodiments, step 1006 further includes generating an interactive carrousel including the sponsored advertisement in a selected slot of the interactive carrousel. In some embodiments, step 1006 includes selecting the targeted advertisement based on a purchasing history of the consumer with a retailer.

Step 1008 includes providing the digital payload to a publishing server for insertion in a media content that is delivered to a client device with the consumer. In some embodiments, step 1008 includes providing a button in the digital payload that communicates the client device for the consumer with a retail media network to purchase a selected product in the digital payload. In some embodiments, step 1008 includes inserting a plugin in the digital payload for the client device with the consumer to access a retail media network of a retailer associated with the sponsored advertisement. In some embodiments, step 1008 includes inserting a plugin in the digital payload, the plugin configured to request the consumer to install an application hosted by a retail media network in the client device.

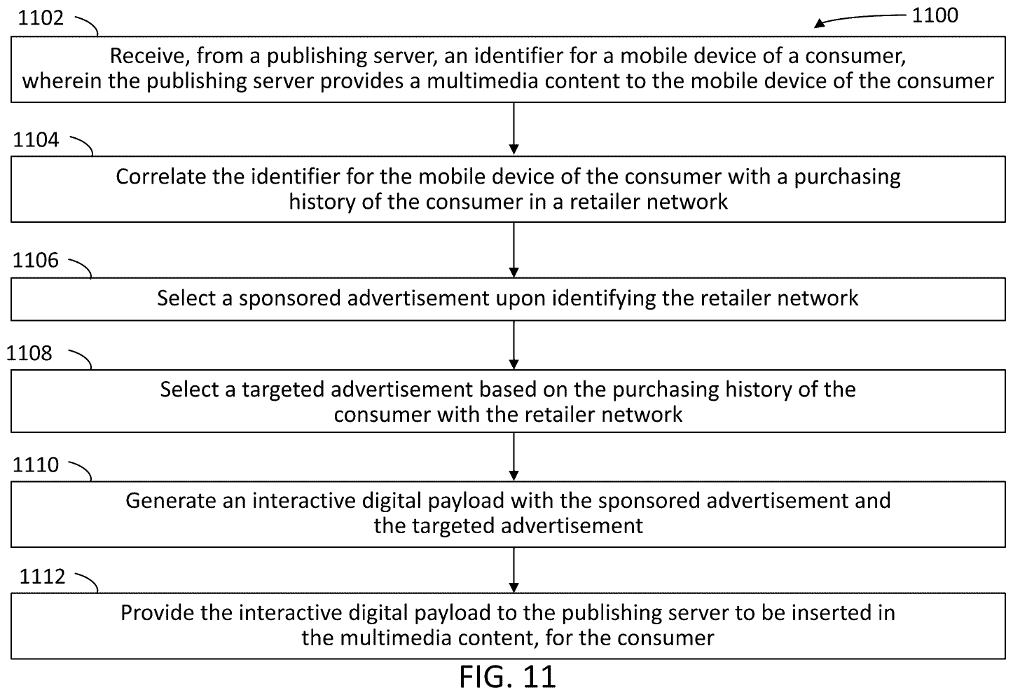

FIG. 11 is a flow chart illustrating steps in a method 1100 for preparing an advertisement carrousel to a consumer (cf. advertisement carrousels 225, 325, 425, 525, 625, and 725), according to some embodiments. Method 1100 may be performed at least partially by any one of a plurality of servers in a network architecture as disclosed herein (cf. servers 130, network architecture 100). For example, at least some of the steps in method 1100 may be performed by one component in a system, including a mobile device running code for a browser and an application to access the publisher website, a digital promotion engine, an MFD engine, and a sponsored advertisement engine (client devices 110, 410, 510, website 322, publisher server 330-2, digital promotion engine 232, MFD engine 332-1, and sponsored advertisement server 332-2). The engines include tools such as a payload tool, a sponsor tool, and an algorithm (cf. payload tool 242, sponsor tools 244 and 344, and algorithm 246). The tools process logic to select an advertisement payload for a dynamic creative rendering server to push the advertisement payload to the mobile device (cf. advertisement payloads, carrousels, or ad units 225, 325, 425, 525, 625, and 725). The publisher SSP server may request advertisement bids from, and is registered with, the DSP server. Accordingly, at least some of the steps in method 1100 may be performed by a processor executing commands stored in a memory of the server, or accessible by the server, and executed by one or more processors (cf. memories 220, processors 212). The servers and the mobile device may be communicatively coupled via a network, with one or more databases (cf network 150 and databases 252). Further, in some embodiments, at least some of the steps in method 1100 may be performed overlapping in time, almost simultaneously, or in a different order from the order illustrated in method 1100. Moreover, a method consistent with some embodiments disclosed herein may include at least one, but not all, of the steps in method 1100.

Step 1102 includes receiving, from a publishing server, an identifier for a mobile device of a consumer, wherein the publishing server provides a multimedia content to the mobile device of the consumer.

Step 1104 includes correlating the identifier for the mobile device of the consumer with a purchasing history of the consumer in a retailer network. In some embodiments, step 1104 includes identifying the retailer network based on a location of the mobile device of the consumer.

Step 1106 includes selecting a sponsored advertisement upon identifying the retailer network. In some embodiments, step 1106 includes retrieving the sponsored advertisement from a list of items requested by multiple retailers, based on a priority and a date associated with each item in the list of items. In some embodiments, step 1106 includes selecting advertisement items from the retailer network.

Step 1108 includes selecting the targeted advertisement based on the purchasing history of the consumer with the retailer network.

Step 1110 includes generating an interactive digital payload with the sponsored advertisement and the targeted advertisement.

Step 1112 includes providing the interactive digital payload to the publishing server to be inserted in the multimedia content, for the consumer. In some embodiments, step 1112 may include updating a list of items requested by multiple retailers to be included in the interactive digital payload. In some embodiments, step 1112 includes bidding with the publishing server for a space in the multimedia content to insert the interactive digital payload. In some embodiments, step 1112 includes processing the structured advertisement content and pushing the interactive digital payload including the structured advertisement content into the mobile device browser or mobile application on the mobile device.

In some embodiments, step 1112 may include determining that the mobile device is within the confines of a retail store subscribed to a system as disclosed herein, wherein CPGs identified with UPCs handled by the MFD engine are sold. Further, in some embodiments, step 1112 may include displaying the playlist for the user. For example, in some embodiments, the playlist includes a carousel of advertisements and offers for a limited number of CPGs (e.g., ten, five, or even less), which may be the few CPGs in the circular prepared by the retail store that the user is most likely to purchase or to at least have an immediate interest, according to the MFD engine. The carousel may be configured to rotate images with an incremental delay between images. When the user clicks on any image, the mobile device may store the UPC for the item that was selected, and an API in the mobile device (e.g., an API handled by the SSP server, such as a mobile wallet) may push a reminder for the user that there is an offer at the retail store for the CPG identified by the UPC.

In some embodiments, step 1112 includes providing a bid for the ad-creative display to a supply side platform hosting the publisher website. In some embodiments, step 1112 includes determining a relevance value for a digital promotion selected from an advertisement database based on a purchase history of a consumer retrieved from a history log database based on the identifier, and sorting multiple digital promotions in the playlist, according to the relevance value provided by the advertisement engine. In some embodiments, step 1112 includes providing a same bid with different advertisement playlists from a same retailer to multiple consumers based on a purchasing history of the consumers retrieved from a history log database based on a different frequent consumer identification identifier for each of the consumers.

In some embodiments, step 1112 includes providing, in the playlist, a link for a user of the mobile device to access a network site hosted by the retailer. In some embodiments, step 1112 includes providing, in the playlist, a plugin to install an application for the retailer in the mobile device. In some embodiments, step 1112 includes providing, in the playlist, a plugin for a user of the mobile device to execute a wallet application installed in the mobile device. In some embodiments, step 1112 includes providing, in the playlist, a plugin for a user of the mobile device to store the playlist in a memory of the mobile device.

### Hardware Overview

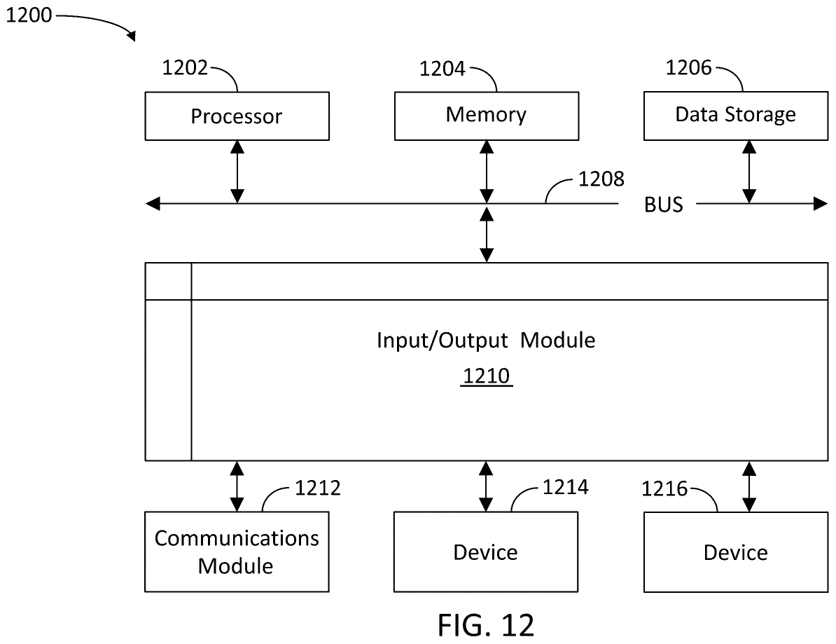

FIG. 12 is a block diagram illustrating an exemplary computer system 1200 with which the client device 110 and server 130 of FIGS. 1 and 2, and the methods of FIGS. 10 and 11 can be implemented. In certain aspects, the computer system 1200 may be implemented using hardware or a combination of software and hardware, either in a dedicated server, or integrated into another entity, or distributed across multiple entities.

Computer system 1200 (e.g., client device 110 and server 130) includes a bus 1208 or other communication mechanism for communicating information, and a processor 1202 (e.g., processors 212) coupled with bus 1208 for processing information. By way of example, the computer system 1200 may be implemented with one or more processors 1202. Processor 1202 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computer system 1200 can include, in addition to hardware, code that creates an execution environment for the computer program in question, e.g., code that constitutes processor firmware, a protocol stack, a database management system, an operating system, or a combination of one or more of them stored in an included memory 1204 (e.g., memories 220), such as a Random Access Memory (RAM), a flash memory, a Read Only Memory (ROM), a Programmable Read-Only Memory (PROM), an Erasable PROM (EPROM), registers, a hard disk, a removable disk, a CD-ROM, a DVD, or any other suitable storage device, coupled with bus 1208 for storing information and instructions to be executed by processor 1202. The processor 1202 and the memory 1204 can be supplemented by, or incorporated in, special purpose logic circuitry.

The instructions may be stored in the memory 1204 and implemented in one or more computer program products, e.g., one or more modules of computer program instructions encoded on a computer-readable medium for execution by, or to control the operation of, the computer system 1200, and according to any method well known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, Wirth languages, and xml-based languages. Memory 1204 may also be used for storing temporary variable or other intermediate information during execution of instructions to be executed by processor 1202.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and intercoupled by a communication network. The processes and logic flows described in this specification can be performed by one or more programmable processors executing one or more computer programs to perform functions by operating on input data and generating output.

Computer system 1200 further includes a data storage device 1206 such as a magnetic disk or optical disk, coupled with bus 1208 for storing information and instructions. Computer system 1200 may be coupled via input/output module 1210 to various devices. Input/output module 1210 can be any input/output module. Exemplary input/output modules 1210 include data ports such as USB ports. The input/output module 1210 is configured to connect to a communications module 1212. Exemplary communications modules 1212 (e.g., communications modules 218) include networking interface cards, such as Ethernet cards and modems. In certain aspects, input/output module 1210 is configured to connect to a plurality of devices, such as an input device 1214 (e.g., input device 214) and/or an output device 1216 (e.g., output device 216). Exemplary input devices 1214 include a keyboard and a pointing device, e.g., a mouse or a trackball, by which a consumer can provide input to the computer system 1200. Other kinds of input devices 1214 can be used to provide for interaction with a consumer as well, such as a tactile input device, visual input device, audio input device, or brain-computer interface device. For example, feedback provided to the consumer can be any form of sensory feedback, e.g., visual feedback, auditory feedback, or tactile feedback; and input from the consumer can be received in any form, including acoustic, speech, tactile, or brain wave input. Exemplary output devices 1216 include display devices, such as an LCD (liquid crystal display) monitor, for displaying information to the consumer.

According to one aspect of the present disclosure, the client device 110 and server 130 can be implemented using a computer system 1200 in response to processor 1202 executing one or more sequences of one or more instructions contained in memory 1204. Such instructions may be read into memory 1204 from another machine-readable medium, such as data storage device 1206. Execution of the sequences of instructions contained in main memory 1204 causes processor 1202 to perform the process steps described herein. One or more processors in a multi-processing arrangement may also be employed to execute the sequences of instructions contained in memory 1204. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., a data server, or that includes a middleware component, e.g., an application server, or that includes a front end component, e.g., a client computer having a graphical consumer interface or a Web browser through which a consumer can interact with an implementation of the subject matter described in this specification, or any combination of one or more such back end, middleware, or front end components. The components of the system can be intercoupled by any form or medium of digital data communication, e.g., a communication network. The communication network (e.g., network 150) can include, for example, any one or more of a LAN, a WAN, the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

Computer system 1200 can include clients and servers. A client and server are generally remote from each other and typically interact through a communication network. The relationship of client and server arises by virtue of computer programs running on the respective computers and having a client-server relationship to each other. Computer system 1200 can be, for example, and without limitation, a desktop computer, laptop computer, or tablet computer. Computer system 1200 can also be embedded in another device, for example, and without limitation, a mobile telephone, a PDA, a mobile audio player, a Global Positioning System (GPS) receiver, a video game console, and/or a television set top box.

The term “machine-readable storage medium” or “computer-readable medium” as used herein refers to any medium or media that participates in providing instructions to processor 1202 for execution. Such a medium may take many forms, including, but not limited to, non-volatile media, volatile media, and transmission media. Non-volatile media include, for example, optical or magnetic disks, such as data storage device 1206. Volatile media include dynamic memory, such as memory 1204. Transmission media include coaxial cables, copper wire, and fiber optics, including the wires forming bus 1208. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter affecting a machine-readable propagated signal, or a combination of one or more of them.

To illustrate the interchangeability of hardware and software, items such as the various illustrative blocks, modules, components, methods, operations, instructions, and algorithms have been described generally in terms of their functionality. Whether such functionality is implemented as hardware, software, or a combination of hardware and software depends upon the particular application and design constraints imposed on the overall system. Skilled artisans may implement the described functionality in varying ways for each particular application.

As used herein, the phrase “at least one of” preceding a series of items, with the terms “and” or “or” to separate any of the items, modifies the list as a whole, rather than each member of the list (e.g., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The word “exemplary” is used herein to mean “serving as an example, instance, or illustration.” Any embodiment described herein as “exemplary” is not necessarily to be construed as preferred or advantageous over other embodiments. Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, and other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A reference to an element in the singular is not intended to mean “one and only one” unless specifically stated, but rather “one or more.” The term “some” refers to one or more. Underlined and/or italicized headings and subheadings are used for convenience only, do not limit the subject technology, and are not referred to in connection with the interpretation of the description of the subject technology. Relational terms such as first and second and the like may be used to distinguish one entity or action from another without necessarily requiring or implying any actual such relationship or order between such entities or actions. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public, regardless of whether such disclosure is explicitly recited in the above description. No claim element is to be construed under the provisions of 35 U.S.C. § 112, sixth paragraph, unless the element is expressly recited using the phrase “means for” or, in the case of a method claim, the element is recited using the phrase “step for.”

While this specification contains many specifics, these should not be construed as limitations on the scope of what may be described, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially described as such, one or more features from a described combination can in some cases be excised from the combination, and the described combination may be directed to a sub-combination or variation of a sub-combination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed, to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products.

### RECITATION OF EMBODIMENTS

The disclosure includes the following embodiments:

Embodiment I: A computer-implemented method includes selecting, based on a prior purchasing behavior for a consumer, a digital payload including a sponsored advertisement and at least one of a targeted advertisement, a coupon, or a discount, for a branded product, selecting a slot for the sponsored advertisement within the digital payload, providing the targeted advertisement, the coupon, or the discount for the branded product in a second slot within the digital payload, and providing the digital payload to a publishing server for insertion in a media content that is delivered to a client device with the consumer.

Embodiment II: A system includes a memory configured to store multiple instructions, and one or more processors configured to execute the instructions and cause the system to perform operations. The operations include to select a digital payload including a sponsored advertisement and at least one of a targeted advertisement, a coupon, or a discount, for a branded product, to select a slot for the sponsored advertisement within the digital payload, provide the targeted advertisement, the coupon, or the discount for the branded product in a second slot within the digital payload, and provide the digital payload to a publishing server for insertion in a media content that is delivered to a client device with a consumer.

Embodiment III: A computer-implemented method includes receiving, from a publishing server, an identifier for a mobile device of a consumer, wherein the publishing server provides a multimedia content to the mobile device of the consumer, correlating the identifier for the mobile device of the consumer with a purchasing history of the consumer in a retailer network, selecting a sponsored advertisement upon identifying the retailer network, selecting the targeted advertisement based on the purchasing history of the consumer, generating an interactive digital payload with the sponsored advertisement and the targeted advertisement, and providing the interactive digital payload to the publishing server to be inserted in the multimedia content, for the consumer.

Embodiments I, II, and III may include any one of the above features, in combination with any number and permutation of the following elements.

Element 1, wherein selecting a digital payload includes selecting the sponsored advertisement from a list provided to a server by a retailer pushing multiple products in an advertising campaign. Element 2, wherein selecting a digital payload includes identifying, from a list of multiple advertisement items provided by multiple retailers, one or more advertisement items from one of the retailers, based on a selected time window of a campaign associated with the advertisement items. Element 3, wherein selecting a digital payload includes selecting the sponsored advertisement and the at least one of the targeted advertisement, the coupon, or the discount associated with a product for sale at a retailer, based on a request from the retailer received in a network server. Element 4, wherein selecting a slot for the sponsored advertisement includes selecting one of a high priority slot or a low priority slot based on a budget provided by a retailer for a product associated with the sponsored advertisement. Element 5, further including generating an interactive carrousel including the sponsored advertisement in a selected slot of the interactive carrousel. Element 6, wherein providing the targeted advertisement includes selecting the targeted advertisement based on a purchasing history of the consumer with a retailer. Element 7, wherein providing the digital payload includes providing a button in the digital payload that communicates the client device for the consumer with a retail media network to purchase a selected product in the digital payload. Element 8, wherein providing the digital payload to a publishing server includes including a plugin in the digital payload for the client device with the consumer to access a retail media network of a retailer associated with the sponsored advertisement. Element 9, wherein providing the digital payload to a publishing server includes including a plugin in the digital payload, the plugin configured to request the consumer to install an application hosted by a retail media network in the client device.

Element 10, wherein correlating the identifier for the mobile device of the consumer with a purchasing history of the consumer in a retailer network includes identifying the retailer network based on a location of the mobile device of the consumer. Element 11, wherein selecting the sponsored advertisement includes retrieving the sponsored advertisement from a list of items requested by multiple retailers, based on a priority and a date associated with each item in the list of items. Element 12, wherein selecting the sponsored advertisement and the targeted advertisement in the interactive digital payload includes selecting advertisement items from the retailer network. Element 13, further including updating a list of items requested by multiple retailers to be included in the interactive digital payload. Element 14, further including bidding with the publishing server for a space in the multimedia content to insert the interactive digital payload.

The title, background, brief description of the drawings, abstract, drawings, and the following claims are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the described subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately described subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A computer-implemented method, comprising:
selecting a digital payload comprising a sponsored advertisement and at least one of a targeted advertisement, a coupon or a discount, for a branded product;
selecting a slot for the sponsored advertisement within the digital payload;
providing the targeted advertisement, the coupon, or the discount for the branded product in a second slot within the digital payload; and
providing the digital payload to a publishing server for insertion in a media content that is delivered to a client device with a consumer.

2. The computer-implemented method of claim 1, wherein selecting a digital payload comprises selecting the sponsored advertisement from a list provided to a server by a retailer pushing multiple products in an advertising campaign.

3. The computer-implemented method of claim 1, wherein selecting a digital payload comprises identifying, from a list of multiple advertisement items provided by multiple retailers, one or more advertisement items from one of the retailers, based on a selected time window of a campaign associated with the advertisement items.

4. The computer-implemented method of claim 1, wherein selecting a digital payload comprises selecting the sponsored advertisement and the at least one of the targeted advertisement, the coupon or the discount associated with a product for sale at a retailer, based on a request from the retailer received in a network server.

5. The computer-implemented method of claim 1, wherein selecting a slot for the sponsored advertisement comprises selecting one of a high priority slot or a low priority slot based on a budget provided by a retailer for a product associated with the sponsored advertisement.

6. The computer-implemented method of claim 1, further comprising generating an interactive carrousel including the sponsored advertisement in a selected slot of the interactive carrousel.

7. The computer-implemented method of claim 1, wherein providing the targeted advertisement comprises selecting the targeted advertisement based on a purchasing history of the consumer with a retailer.

8. The computer-implemented method of claim 1, wherein providing the digital payload comprises providing a button in the digital payload that communicates the client device for the consumer with a retail media network to purchase a selected product in the digital payload.

9. The computer-implemented method of claim 1, wherein providing the digital payload to a publishing server comprises including a plugin in the digital payload for the client device with the consumer to access a retail media network of a retailer associated with the sponsored advertisement.

10. The computer-implemented method of claim 1, wherein providing the digital payload to a publishing server comprises including a plugin in the digital payload, the plugin configured to request the consumer to install an application hosted by a retail media network in the client device.

11. A system, comprising:
a memory configured to store multiple instructions; and
one or more processors configured to execute the instructions and cause the system to perform operations, comprising to:
select a digital payload comprising a sponsored advertisement and at least one of a targeted advertisement, a coupon or a discount, for a branded product;
select a slot for the sponsored advertisement within the digital payload;
provide the targeted advertisement, the coupon or the discount for the branded product in a second slot within the digital payload; and
provide the digital payload to a publishing server for insertion in a media content that is delivered to a client device with a consumer.

12. The system of claim 11, wherein to select a digital payload the one or more processors further execute instructions to select the sponsored advertisement from a list provided to a server by a retailer pushing multiple products in an advertising campaign.

13. The system of claim 11, wherein to select a digital payload the one or more processors further execute instructions to identify, from a list of multiple advertisement items provided by multiple retailers, one or more advertisement items from one of the retailers, based on a selected time window of a campaign associated with the advertisement items.

14. The system of claim 11, wherein to select a digital payload the one or more processors further execute instructions to select the sponsored advertisement and the at least one of the targeted advertisement, the coupon or the discount associated with a product for sale at a retailer, based on a request from the retailer received in a network server.

15. A computer-implemented method, comprising:
receiving, from a publishing server, an identifier for a mobile device of a consumer, wherein the publishing server provides a multimedia content to the mobile device of the consumer;
correlating the identifier for the mobile device of the consumer with a purchasing history of the consumer in a retailer network;
selecting a sponsored advertisement upon identifying the retailer network;
selecting a targeted advertisement based on the purchasing history of the consumer with the retailer network;
generating an interactive digital payload with the sponsored advertisement and the targeted advertisement; and
providing the interactive digital payload to the publishing server to be inserted in the multimedia content, for the consumer.

16. The computer-implemented method of claim 15, wherein correlating the identifier for the mobile device of the consumer with a purchasing history of the consumer in a retailer network comprises identifying the retailer network based on a location of the mobile device of the consumer.

17. The computer-implemented method of claim 15, wherein selecting the sponsored advertisement comprises retrieving the sponsored advertisement from a list of items requested by multiple retailers, based on a priority and a date associated with each item in the list of items.

18. The computer-implemented method of claim 15, wherein selecting the sponsored advertisement and the targeted advertisement in the interactive digital payload comprises selecting advertisement items from the retailer network.

19. The computer-implemented method of claim 15, further comprising updating a list of items requested by multiple retailers to be included in the interactive digital payload.

20. The computer-implemented method of claim 15, further comprising bidding with the publishing server for a space in the multimedia content to insert the interactive digital payload.
